(19) United States
(12) Patent Application Publication
(10) Pub. No.: US 2024/0092030 A1
(43) Pub. Date: Mar. 21, 2024

(54) 3D PRINTER SYSTEM INCLUDING G-CODE CONVERSION PROCESS AND HARDWARE ABSTRACTION LAYER

(71) Applicant: Essentium IPCO, LLC, Pflugerville, TX (US)

(72) Inventors: Omar Yasser Hegazy, Long Beach, CA (US); Chad Eichele, Lake Forest, CA (US); Faisal Altoukhy, Rancho Santa Margarita, CA (US); Iris Gisey Euan Waldestrand, Puebla (MX); Jorge Arturo Mijares Tobias, Puebla (MX); Matthew Skolaut, Houston, TX (US); William Jack MacNeish, III, Santa Ana, CA (US)

(21) Appl. No.: 18/495,104

(22) Filed: Oct. 26, 2023

Related U.S. Application Data
(63) Continuation of application No. PCT/US2022/026497, filed on Apr. 27, 2022.
(60) Provisional application No. 63/180,932, filed on Apr. 28, 2021.
(60) Provisional application No. 63/180,971, filed on Apr. 28, 2021.

(51) Int. Cl. B29C 64/393; B33Y 50/02

(52) U.S. Cl. CPC B29C 64/393; B33Y 50/02

(57) ABSTRACT

In an example implementation, a system including a computer including a processor and a memory. The memory includes instructions such that the processor is programmed to convert G-code to G-node data, generate a plurality of windows based on G-node segments, calculate an average velocity based on the plurality of windows, where the velocity corresponds to a 3D printer head. The processor is also programmed to determine a temperature corresponding to the average velocity, and insert a G-code heat command into a G-code command file based on the determined temperature. The processor can be further programmed to insert a pre-heat G-code command into the G-code command file.

### CROSS-REFERENCE TO RELATED APPLICATIONS

This application claims priority to U.S. Application No. 63/180,971 filed on Apr. 28, 2021 and U.S. Application No. 63/180,932 filed on Apr. 28, 2021.

### FIELD

The present disclosure is directed to systems that receive instructions in the form of sequential programs of machine control instructions, known as G-code. Systems that run with G-code use computer numerical control (CNC), such as systems for 3D printing, mills, lathes, etc. The present disclosure is a tool and a method for analyzing G-code parameters and optimizing prior execution in a CNC system, this is being used but not limited to 3D printers.

The present disclosure is also directed to systems that receive instructions in the form of sequential programs of machine control instructions, known as G-code. Systems that run with G-code use computer numerical control (CNC), such as systems for 3D printing, mills, lathes, etc. The present disclosure is a tool and a method for analyzing G-code parameters and optimizing prior execution in a CNC system, this is being used but not limited to 3D printers

### BACKGROUND

Three-dimensional (3D) printing provides a way of quickly producing prototype devices and there are many different 3D printing technologies that may be used, including stereo-lithography, selective laser sintering and fused filament fabrication (FFF), which is also referred to as fused deposition modeling (FDM). Although fabrication of a prototype using 3D printing is rapid compared to conventional techniques such as injection molding, it can still take many hours, depending on the size of the object and the maximum size of prototypes that can be formed is limited by the printing envelope (or tray size) of the 3D printer.

3D printers utilize a set of instructions, typically in the form of a computer numerical control programming language, to direct the movements of the print head when depositing filament on the print platform. While the print instructions may be manually programed, print instructions are often automatically programmed through computer aided machining (CAM) software that derives the g-code from a computer aided design (CAD) file. For 3D printing, the CAD file representing the three-dimensional (3D) object is manipulated by the slicing software to define the printed object scale relative to the design scale, slice the 3D object into a number of layers with a motion path based on, for example, an assumed trace height and width, divide the object up into chords or segments, define infill, and determine exposed wall thicknesses. Then for each layer, a series of actions is created for moving the print head and depositing the filament. Such actions include defining a home position, starting and stopping locations, distances of travel, rates of travel, interpolation of mid-points, returns to the home position, extrusion rate, etc. The series of actions are codified as print instructions as g-code or another form of numerical control code. These instructions are then provided to and executed by the 3D printer.

G-code, which is output from a slicer that processes a 3D object into layers for a target 3D printing system, may not be in an optimized condition. The series of actions described above do not allow for optimizing printing conditions that may ultimately affect part quality before operation of a 3D printer. For example, a programmer entering data does not presently have the capability to modify features such as velocity, time, temperature and flow rate and obtain an analysis of the impacts of each change without first entering the G-code file data into a 3D printer and performing a 3D print operation.

### SUMMARY

The present disclosure relates to a system including a computer including a processor and a memory. The memory includes instructions such that the processor is programmed to convert G-code to G-node data, generate a plurality of windows based on G-node segments, calculate an average velocity based on the plurality of windows, where the velocity corresponds to a 3D printer head. The processor is also programmed to determine a temperature corresponding to the average velocity, and insert a G-code heat command into a G-code command file based on the determined temperature.

In other features, the processor is further programmed to insert a pre-heat G-code command into the G-code command file.

In other features, the processor is further programmed to determine the pre-heat G-code command based on a calculated heat time defining a time unit prior to when a non-active print head transitions to an active state.

In other features, the processor is further programmed to determine the pre-heat G-code command based on a heat time defining a time unit prior to when a non-active print head transitions to an active state.

In other features, the G-node data comprises at least one of a time to produce a line, a quantity of head movements, a head direction, a time to print a line, or maximum velocities at corners.

In other features, the processor is further programmed to generate the plurality of G-node segments.

In other features, the plurality of G-node segments include G-node data corresponding to at least one print head.

In other features, the G-node segments include at least one segment separator that separates G-node data corresponding to a first print head from G-node data corresponding to a second print head.

In other features, each window of the plurality of windows comprise a set of G-node data.

In other features, the processor is further programmed to assign the set of G-node data based on a time parameter.

In other features, the processor is further programmed to assign the set of G-node data such that a sum of total time parameters of the set of G-node data does not exceed a predetermined time threshold.

In other features, the processor is further programmed to generate a new window when the sum exceeds the predetermined time threshold.

In other features, the processor is further programmed to assign another set of G-node data to the new window.

In other features, the processor is further programmed to access a lookup table to determine the G-code heat command to insert into the G-code command file.

In other features, the lookup table includes a linear model that relates overall average velocity to a temperature for a heated nozzle.

In other features, the overall average velocity corresponds to a sum of x-y velocities of individual G-code commands within at least one window of the plurality of windows.

In other features, the lookup table includes a polynomial model that relates overall average velocity to a temperature for a heated nozzle.

In other features, the overall average velocity corresponds to a sum of x-y velocities of individual G-code commands within at least one window of the plurality of windows.

The present disclosure relates to a system including a computer including a processor and a memory. The memory includes instructions such that the processor is programmed to retrieve 3D printer identification data, access and retrieve 3D print job data from at least one repository based on an input and the 3D printer identification data, and generate a command file based on the 3D print job data.

In other features, the at least one repository comprises at least one of a vendor domain repository, an application programming interface (API) wrapper repository, or a G-node repository.

In other features, the command file is transmitted to a 3D printer to perform a print job according to the command file.

### BRIEF DESCRIPTION OF THE DRAWINGS

The drawing described herein are for illustration purposes only and are not intended to limit the scope of the present disclosure in any way.

FIG. 1 illustrates a facet of a 3D printer including a print head carried by an x-y carriage, according to an example implementation of the present disclosure;

FIG. 2A illustrates an aspect of a print head, a print platform, a cooling fan and a 3D printed object on the print platform, according to an example implementation;

FIG. 2B illustrates an aspect of a dual-head print head system according to an example implementation;

FIG. 2C illustrates example unmodified G-code according to example implementation;

FIG. 2D illustrates an example computing device;

FIG. 3A illustrates a flow diagram of a first portion of a G-code processor defining a G-node factory applying the machine parameters according to an example implementation of the present disclosure;

FIG. 3B illustrates an example block diagram of a plurality of segments according to an example implementation, where each segment includes a plurality of windows;

FIG. 4 illustrates a flow diagram of a process for optimizing G-code based on G-node data;

FIG. 5 illustrates modified G-code according to an example implementation of the present disclosure;

FIG. 6 illustrates a flow diagram of a second portion of the G-code processor defining a G-node toolbox that contains analyses modules according to an example implementation of the present disclosure;

FIG. 7 illustrates an example logical architecture of the computing device; and

FIG. 8 illustrates a flow diagram of process for operating a 3D printer via a computing device.

### DETAILED DESCRIPTION

The present disclosure relates to a process and method for analyzing a computer numerical control code, for example for use in a system for 3D printing. The process and method take into account control commands and machine parameters to assist in the printing process development.

As noted above, 3D printers utilize a set of instructions, typically in the form of a computer numerical control programming language, to direct the movements of a print head when depositing filament on the print platform. The computer numerical control code often used include G-code, however, other numerical control codes may alternatively be used. A computer aided design (CAD) file is used to develop a 3D part which is then passed through a slicer software or a computer aided machining (CAM) software to generate the G-code. In aspects, the processes are coded or embodied by one or more of a number of programming languages including, but not limited to, at least one of the following: C#, C++, Python, and Java.

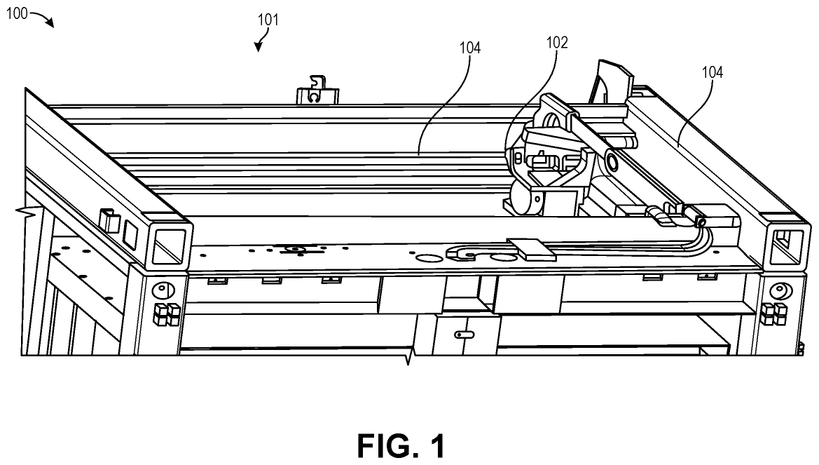

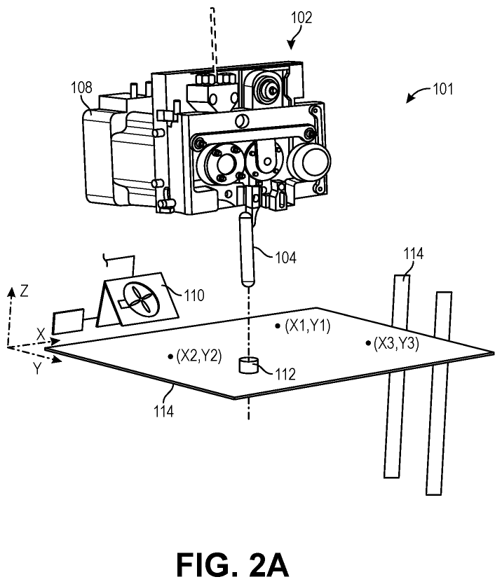

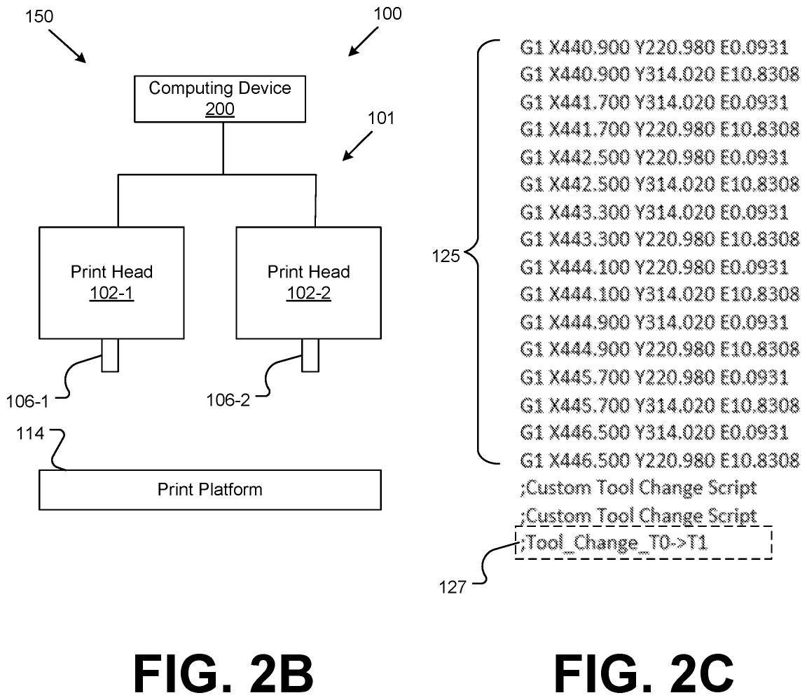

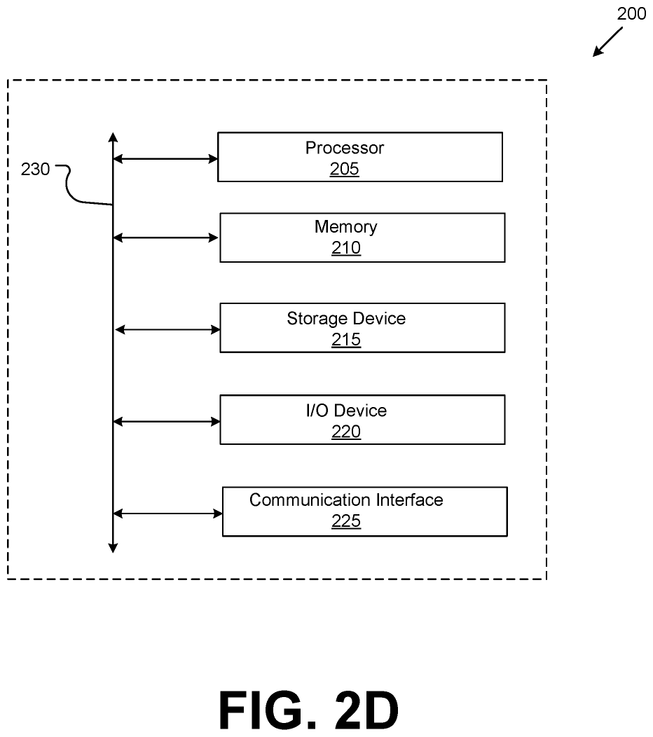

FIGS. 1 through 2B and FIG. 2D illustrate an aspect of a system 100 for printing 3D objects. The system 100 includes a 3D printer 101. The 3D printer 101 includes a print head 102 carried by an x-y carriage 104. The print head 102 includes a heated nozzle 106 and a feed motor 108. The system 100 may further include a fan 110 for cooling the heat brake of the heated nozzle 106 and printed 3D object 112. A print platform 114 is further provided upon which the 3D object 112 is printed. The print platform 114 is moveable in the z-direction relative to the print head 102 to accommodate layers of extruded filament as the 3D object 112 is printed. Operation of the system 100 including the print head 102, the carriage 104, the nozzle 106, the feed motor 108, the fan 110 and the print platform 114 are controlled from commands received from a computing device 200.

FIG. 2B illustrates an example implementation of a dual-head system 150 for printing 3D objects. As shown, the 3D printer 101 can include a first print head 102-1 and a second print head 102-2. The dual-head system 100 can include one or components for operating the print heads 102-1, 102-2 as discussed above with respect to the system 100. The print heads 102-1, 102-2 may be operated based on commands received from the processor 205. FIG. 2C illustrates G-code according to an example implementation. In the G-code illustrated, G-code commands 125 correspond to G-code for the operating the first print head 102-1. G-code command 127 represents a G-code command to transition print operation for printing the 3D object 112 to the second print head 102-2.

FIG. 2D illustrates an example computing device 200 that is communicatively connected to the 3D printer 101 and is configured to perform one or more of the processes described herein. As shown, the computing device 200 can comprise a processor 205, memory 210, a storage device 215, an I/O interface 220, and a communication interface 225. Furthermore, the computing device 200 can include an input device such as a touchscreen, mouse, keyboard, etc. In certain implementations, the computing device 200 can include fewer or more components than those shown in FIG. 2D.

In particular implementations, processor 205 includes hardware for executing instructions, such as those making up a computer program. As an example, and not by way of limitation, to execute instructions, processor 205 may retrieve (or fetch) the instructions from an internal register, an internal cache, memory 210, or a storage device 215 and decode and execute them.

The computing device 200 includes memory 210, which is coupled to the processor 205. The memory 210 may be used for storing data, metadata, and programs for execution by the processor(s). The memory 210 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 210 may be internal or distributed memory.

The computing device 200 includes a storage device 215 includes storage for storing data or instructions. As an example, and not by way of limitation, storage device 215 can comprise a non-transitory storage medium described above. The storage device 215 may include a hard disk drive (HDD), flash memory, a Universal Serial Bus (USB) drive or a combination of these or other storage devices.

The computing device 200 also includes one or more input or output (“I/O”) devices/interfaces 220, which are provided to allow a user to provide input to (such as user strokes), receive output from, and otherwise transfer data to and from the computing device 200. These I/O devices/interfaces 220 may include a mouse, keypad or a keyboard, a touch screen, camera, optical scanner, network interface, modem, other known I/O devices or a combination of such I/O devices/interfaces 220. The touch screen may be activated with a writing device or a finger.

The I/O devices/interfaces 220 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 220 is configured to provide graphical data to a display for presentation to a user. The graphical data may be representative of one or more graphical user interfaces and/or any other graphical content as may serve a particular implementation.

The computing device 200 can further include a communication interface 225. The communication interface 225 can include hardware, software, or both. The communication interface 225 can provide one or more interfaces for communication (such as, for example, packet-based communication) between the computing device and one or more other computing devices 200 or one or more networks. As an example, and not by way of limitation, communication interface 225 may include a network interface controller (NIC) or network adapter for communicating with an Ethernet or other wire-based network or a wireless NIC (WNIC) or wireless adapter for communicating with a wireless network, such as a WI-FI. The computing device 200 can further include a bus 230. The bus 230 can comprise hardware, software, or both that couples components of computing device 200 to each other.

The processor 205 receives static computer numerical control code (G-code) files and includes hardware, firmware, and software for parsing, analyzing, and optimizing the G-code and provides an optimized executable code which may then be loaded as low-level servo controller optimizations for use by the 3D printer 101.

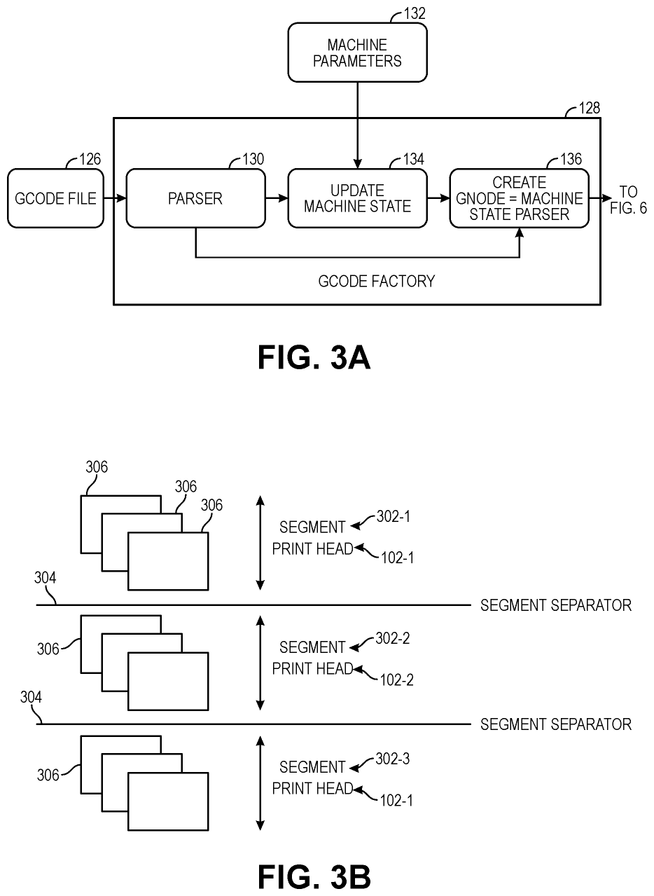

With reference to FIG. 3A, a G-code analysis tool 124 receives G-code in a data text file 126 in a first portion 128 which is sent through a parser 130. Machine parameters 132 such as velocity, time, acceleration, temperature, motion and flow rate are entered into the first portion 128 and are used together with an output from the parser 130 to update a machine state 134. An output from the updated machine state 134 is used to create a G-node 136 which is defined as a sum of the updated machine state plus the output of the parser 130. The G-node 136 contains data that can be extracted such as a time to produce a line, a quantity of head movements, head direction, time to print a line, maximum velocities at corners, and the like.

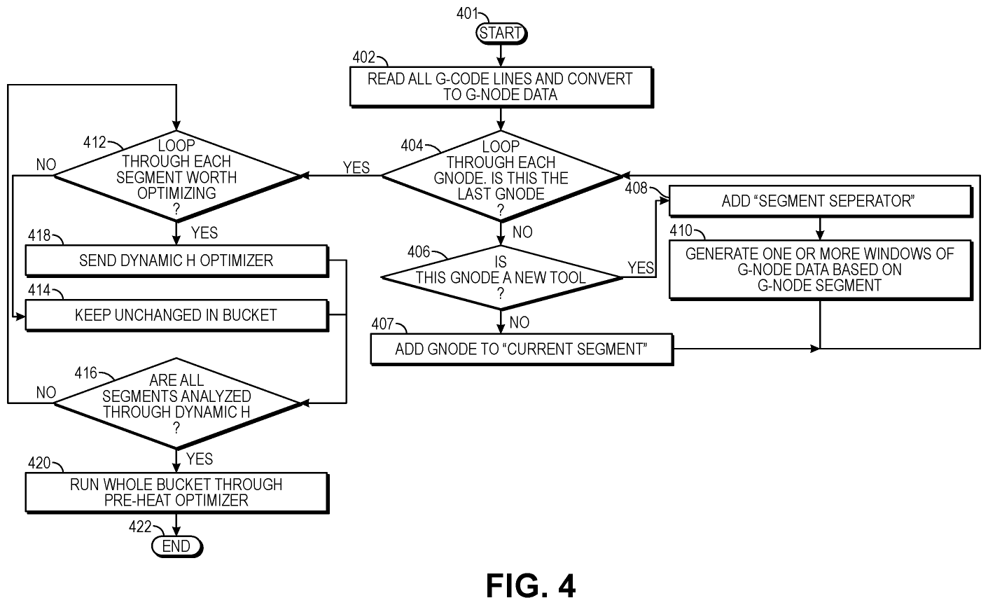

FIG. 3B illustrates multiple G-node segments 302-1, 302-2, 302-3 that can be generated by the processor 205, as discussed in greater detail below with respect to FIG. 4. Each G-node segment 302-1, 302-2, 302-3 can be separated by a segment separator 304 that separates G-nodes 136 corresponding to one print head, e.g., print head 102-1, from G-nodes 136 corresponding to another print head, e.g., print head 102-2. Each G-node segment 302-1, 302-2, 302-3 can include one or more windows 306. Windows 306 can comprise a set or a sub-set of G-node data 136. For example, each window 306 can include one or more G-nodes 136 for a particular print head.

The processor 205 can assign G-nodes 136 to a window 306 based on a time parameter of the G-nodes 136. In an example implementation, the time parameter may comprise the time to produce a line and/or the time to print the line. For example, each window 306 may be set to include a number of G-node 136 data such that a sum of total time parameters of the G-node 136 data does not exceed a predetermined time threshold. The processor 205 can sum the time parameters for each G-node 136 and assign the G-node 136 to a window 306 if the predetermined time threshold is not exceeded. If adding the time parameter of the current G-node 136 to the current window 306 would case the sum to exceed the predetermined time threshold, a new window 306 is created and the current G-node 136 is assigned to the newly created window 306.

FIG. 4 illustrates an example method 400 for optimizing G-code based on the G-node 136. As shown, the method 400 begins at 401. The blocks of the method 400 may be executed via the processor 205. At block 402, G-code data, e.g., via the G-code file 126, is received and converted to corresponding G-node 136 data via the G-code analysis tool 124. At block 404, the processor 205 can loop through each G-node 136 generated and determine whether the current G-node 136 is the last G-node 136. If the G-node 136 is not the last G-node 136, a determination is made whether the G-node 136 corresponds to a G-code instruction for a different print head, i.e., transitioning to print head 102-1 to print head 102-2 or vice versa via a G-code command 127, at block 406. If G-node 136 does not correspond to a different print head, the processor 205 inserts the current G-node 136 data to the current segment 302 at block 407, and the method 400 returns to block 404.

Otherwise, the processor 205 can insert a segment separator 304 at block 408 to define a segment 302 of G-node 136 data. As discussed above, the segment separator 304 separates G-node 136 data corresponding to one print head from G-code corresponding to another print head. G-node 136 data corresponding to one print head may be defined as a segment 302 of G-node 136 data. At block 410, one or more windows 306 are generated based on the current segment 302 of G-node 136 data. As discussed above, the processor 205 can generate one or more windows 306 within the segment 302. The method 400 then returns to block 404.

Referring to block 404, if the processor 205 determines that the G-node 136 is the last G-node, the processor 205 determines whether each segment 302 can be optimized at block 412. The processor 205 can determine whether a segment 302 can be optimized based on a number of windows 306 within the segment 302. If the number of windows 306 is above a predetermined window threshold, the processor 205 determines that the segment 302 can be optimized. If the processor 205 determines that the number of windows 306 within the segment 302 is less than the predetermined window threshold, the segment 302 of G-node 136 data is not modified at block 414 and the method 400 continues to block 416.

Otherwise, the processor 205 optimizes the segment 302 at block 418. In an example implementation, the processor 205 can parse the windows 306 to determine an average print head velocity for a current window 306, e.g., referred to as the ith window 306 where i is an integer greater than or equal to 1. The processor 205 can further determine an average print head velocity for the i+1 window 306 and calculate an overall average print head velocity for the ith and the i+1 windows 306. Typically, there is a correlation between velocity of a print head to a desired temperature for the print head. The processor 205 can access a lookup table that relates velocities to temperatures for the heated nozzle 106. In an example implementation, the lookup table can store a linear model that relates overall average velocity to a temperature for the heated nozzle 106. However, it is understood that the lookup table may also store a polynomial model that relates overall average velocity to a temperature for the heated nozzle 106. In an example implementation, the velocity corresponds to a sum of x-y velocities of individual G-code commands within a certain window or a segment.

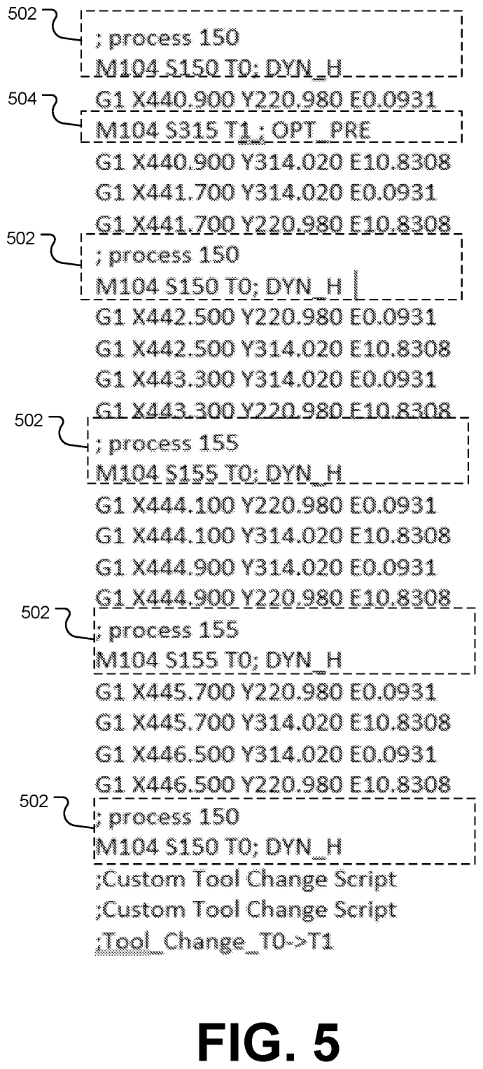

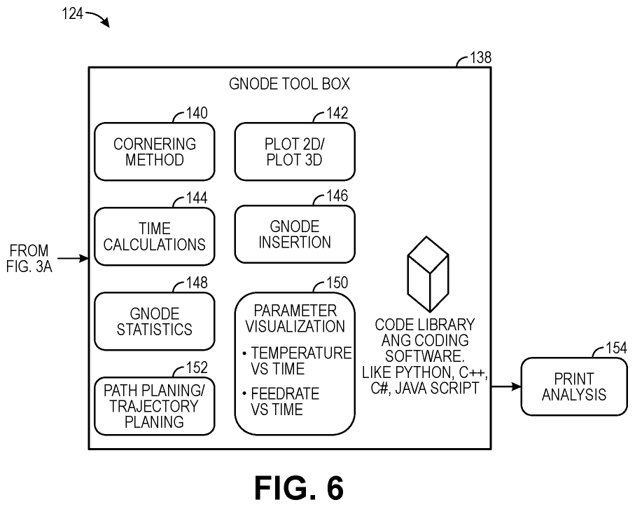

The processor 205 can then insert a G-code heat command (see FIG. 5) that causes the heated nozzle 106 of print head 102-1, 102-2 to transition to a set temperature corresponding to the calculated average velocities when the print head 102-1, 102-2 is operating according to the G-code commands corresponding to the ith and the i+1 windows 306.

The processor 205 scan determines whether all of the segments 302 have been analyzed at block 416. If all of the segments 302 have not been analyzed, the method 400 returns to block 412. Otherwise, the processor 205 optimize the G-node 136 data for print head heating at block 420. In an example implementation, the processor 205 can be programmed to insert a pre-heat G-code command for a non-active print head 102-1, 102-2 at a calculated heat time.

The non-active print head 102-1, 102-2 can be defined as the print head 102-1, 102-2 not currently printing. The calculated heat time may be defined as a time unit prior to when the non-active print head 102-1, 102-2 transitions to being the active print head. In an example implementation, the processor 205 iterate through the segment 302 and insert a pre-heat G-code command at the calculated heat time. The pre-heat G-code command, when executed by the processor 205 actuates one or more heating components such that the heated nozzle 106 of the non-active print head 102-1, 102-2 approaches a temperature for the non-active print head 102-1, 102-2 defined within the next segment 302. The process 400 ends at block 422. The processor 205 can calculate the heat time dynamically. For example, the processor 205 can calculate the heat time based on a heating speed of the nozzle (Celsius/second), a target temperature, and a current/standby temperature the nozzle 106 is currently at.

FIG. 5 illustrates example modified G-code generated by the processor 205 as discussed above with respect to FIG. 4. As shown in FIG. 5, G-code commands 502 represent heat commands based on the overall average print head velocity for corresponding windows 306. A pre-heat G-code command 504 has also been inserted within G-code that corresponds to the calculated heat time.

With reference to FIG. 6 and again to FIG. 3, the G-node 136 from the first portion 128 is passed to a second portion 138 also defined as a G-node toolbox. The second portion 138 provides multiple different inputs which may be used to alter or analyze the G-node 136 or a group of G-nodes. These include data including multiple cornering methods 140 which may be selected. A plot decision 142 is entered such as whether a 2D plot or a 3D plot is desired. Multiple time calculations 144 may be entered which allow for example the G-code analysis tool 124 to identify a total time of deposition, for example by layer, an average time of deposition, a time at temperature, a temperature distribution and the like. A G-code insertion 146 is provided which allows for example movement of lines, and insertion of new instructions. Multiple G-code statistics 148 may also be entered, which may include but are not limited to average temperature at different locations, mean data points, standard deviations of velocities, and the like. Multiple parameters visualizations 150 may be entered which may include but are not limited to print material temperature versus time, a feed rate versus time, and print head velocity versus time. Multiple planning features 152 may also be entered, which may include but are not limited to a material path plan and a trajectory plan. This allows for example to pre-plan print head optimized motion to minimize lost time occurring when the print head must move between rows or layers.

The items entered by the operator or programmer into the second portion 138 of the G-code analysis tool 124 produce one of multiple different print analyses 154. The print analyses 154 individually define projected or estimated conditions of a finished 3D part without the need at this time to run the 3D printer 101. Further optimization of the projected 3D part based on one or more additional print analyses 154 may be conducted by further modifying any of the data entered into the second portion 138 or by e-slicing with different parameters to create a new G-code file 124 to produce further print analyses 154 and comparing results between different print analyses 154.

The G-code analysis tool 124 includes a method to parse G-code and identify a machine state at every motion command. The G-code analysis tool 124 allows modification/optimization of the G-code to improve machine performance and part quality. The G-code analysis tool 124 analyzes the G-code and allows visibility to statistics of the manufacturing process.

The G-code analysis tool 124 can be used either offline or online. The G-code analysis tool 124 allows path/trajectory simulations. The G-code analysis tool 124 and the method of operation of the G-code analysis tool 124 can be applied to any G-code and machine using predetermined machine specifics.

The inputs to the G-code analysis tool 124 are any G-code, and the machine parameters for an initial machine conditions may be optionally included. The G-code analysis tool 124 can be used in a single line of G-code, in a section of a G-code file, or in one or several G-code files. The G-code analysis tool 124 analyzes the G-code line-by-line and generates information after any motion command, called a G-node.

The information available at every G-node includes the state of the machine, the elapsed time for the motion command, and this information can be used for path/trajectory planning and simulations.

An overview of the process of the present disclosure is provided as follows:
1) CAD/CAM software is used to create a part in 3-D;
2) Slicer software is applied to take an output file of the CAD/CAM software and slice it
up into layers and parameters for a target printer such as a 3D printer;
3) Static G-CODE analyzer software of the present disclosure takes the G-code
produced by the slicer software and provides a data analysis to evaluate the performance of the g-code on the desired machine;
4) The analysis is used to optimize/improve parameters of the slicer and generate a new g-code or to insert G-codes to optimize/improve the current g-code file; and
5) Printer parsing/optimization: Consumes the optimized G-code and queues it up in an optimized fashion for the 3D printer.

The process and method of the present disclosure offers several advantages, including but not limited to optimizing G-code based on the G-node. For example, one or more windows of G-node data are generated based on G-node segments. A G-code processor can determine a temperature based on a calculated overall average velocity using the one or more windows and insert a G-code heat command into a G-code file. The G-code processor can also insert pre-heat G-code commands into the G-code file at predetermined times using the windows.

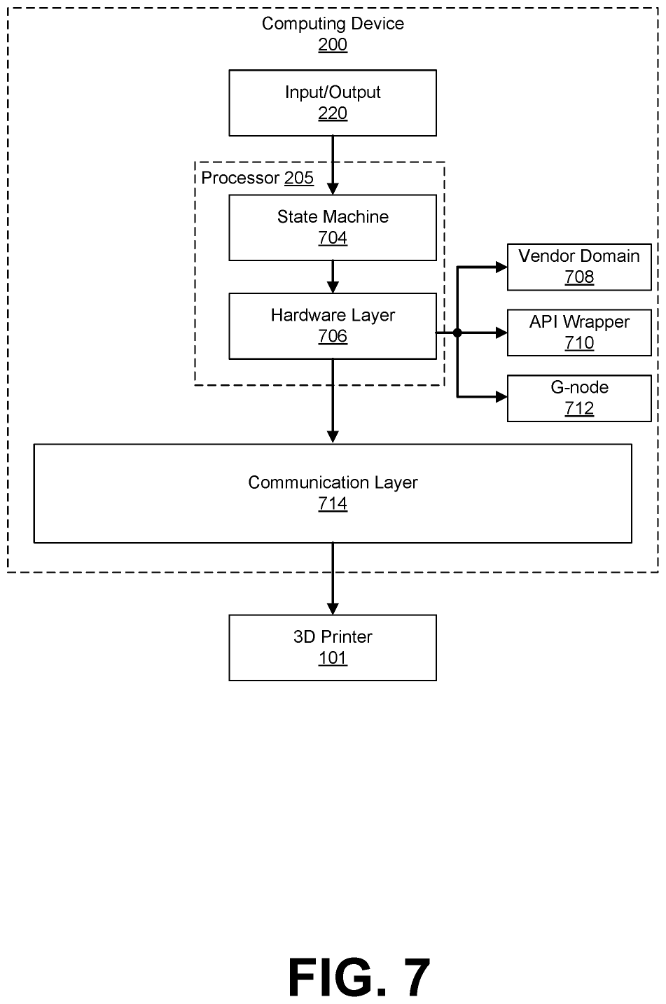

FIG. 7 illustrates an example logical architecture of the computing device 200 that can operate the 3D printer 101 in accordance with the functionality described herein. As shown, the computing device 200 includes the I/O devices 220, which can display a graphical user interface (GUI) to a user during operation. The GUI can allow the user to select one or more operations to operate the 3D printer 101.

The computing device 200 also includes a state machine 704 that comprises a logical layer that controls one or more functions presented to the user via the GUI. For example, based on a user's selection via the GUI, the state machine 304 can present a finite number of functions, e.g., selections, available to the user for the next selection. Thus, a user's selection determines a limited number of states available to the user in subsequent steps. In some implementations, the state machine 704 can access 3D printer 101 identification data. For example, once the computing device 200 is connected to the 3D printer 101, the state machine 704 may request identification data from the 3D printer 101. The identification data may comprise data representing a vendor of the 3D printer 101, hardware, software, and/or firmware data of the 3D printer 101, or the like. The state machine 704 may also limit a number of states, e.g., functions, presented to the user based on the 3D printer 101 identification data.

A hardware abstraction layer 706 can receive inputs from the state machine 304 and generate output for controlling the 3D printer 101. For example, the user selection is provided to the hardware abstraction layer 706 from the state machine 704. Based on the user selection and the 3D printer 101 identification data, the hardware abstraction layer 706 can an access a vendor's domain repository 708, a wrapper for the vendor's application programming interface (API) 710, and/or a G-node repository 712.

The vendor's domain repository 708 can store constant values, dictionaries, and enumerations corresponding to one or more motion control vendors. The hardware abstraction layer 706 uses the vendor values on the domain repository 708 to map 3D printing parameters selected on the state machine 704 to controller parameters from the motion control vendor.

The wrapper for the vendor's application programming interface (API) wrapper 710 can store modules, programming objects, controller data, corresponding to one or more motion control vendors. In some examples, the hardware abstraction layer 706 may include a lookup table that relates user actions from the state machine 704 to vendor features and actions within the wrapper repository 710. The hardware abstraction layer 706 uses the 3D printer identification data to select the features, data and objects from the wrapper that are available and needed by the identified 3D printer.

The G-node repository 712 can store G-node data that can operate print head 102. For example, G-node data can be defined as a sum of an updated machine state plus an output of a parser. In an example implementation, a G-code analysis tool can receive G-code data stored within a data text file . Thus, G-node data corresponds to G-code data. In some instances, the G-node repository 712 includes corresponding G-code data. The G-node data can be defined as G-code data that can be extracted, such as a time to produce a line, a quantity of head movements, head direction, time to print a line, maximum velocities at corners, and the like.

Based on the user selection received from the state machine 704, the hardware abstraction layer 706 accesses the vendor's domain repository 708, the API wrapper repository 710, and/or the G-node repository 710 to retrieve data for constructing a command file for the 3D print 101. The command file can contain G-code for operating the print head 102, 3D printer 101 controller data, etc., for controlling a controller of the 3D printer 101, and/or constants used by the 3D printer 101.

The command file is output from the hardware abstraction layer 706 to the communication layer 714. The communication layer 714 can comprise suitable communication protocols, i.e., protocol suite, for allowing communicating between the computing device 200 and the 3D printer 101. In some implementations, the communication layer 714 is specific to the 3D printer 101. The communication layer 714 transmits the command file to the 3D printer 101 such that the 3D printer 101 is actuated in accordance with the data within the command file. The communication layer 714 can also receive data from the 3D printer 101 to provide to the processor 205. The received data may be output to the I/O device 220 to inform the user of the progress of the print job.

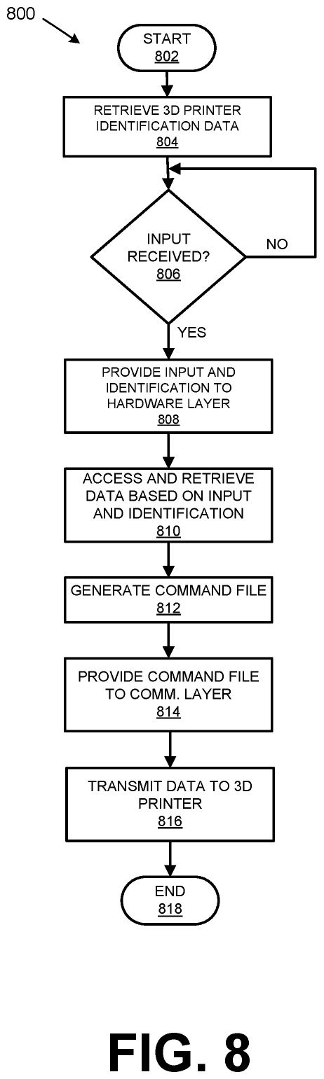

FIG. 8 illustrates a flow diagram of a process 800 for operating a 3D printer 101 via a computing device 200. Blocks of the process 800 can be executed by the processor 205 in accordance with an example implementation of the present disclosure.

The process 800 begins at block 802. At block 804, the state machine 704 retrieves identification data from the 3D printer 101. At 806, the state machine 704 determines whether an input, e.g., selection, has been received via the I/O device 220. If no input has been received, the process 800 returns to block 806. In some implementations, the state machine 704 may cause the I/O device 220 to present additional selections to the user for the purposes of defining the print job. If input has been received, the state machine 704 provides the input for the print job to the hardware abstraction layer 706 at block 808.

At block 810, the hardware abstraction layer 706 accesses and retrieves data from the vendor's domain repository 708, the API wrapper repository, and/or the G-node repository 712 that corresponds to the selection and the identification data. At block 812, the hardware abstraction layer 706 generates a command file using the data from the vendor's domain repository 708, the API wrapper repository, and the G-node repository 712 to operate the 3D printer 101. At block 814, the hardware abstraction layer 706 provides the command file to the communication layer 714. At block 816, the network layer transmit data defined within the command file to the 3D printer 101 such that the 3D printer operates in accordance with data within the command file. The process 800 ends at block 818.

In general, the computing systems and/or devices described may employ any of a number of computer operating systems, including, but by no means limited to, versions and/or varieties of the AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
convert G-code to G-node data;
generate a plurality of windows based on a plurality of G-node segments;
calculate an average velocity based on the plurality of windows, wherein the velocity corresponds to a 3D printer head;
determine a temperature corresponding to the average velocity; and
insert a G-code heat command into a G-code command file based on the determined temperature.

2. The system as recited in claim 1, wherein the processor is further programmed to insert a pre-heat G-code command into the G-code command file.

3. The system as recited in claim 2, wherein the processor is further programmed to determine the pre-heat G-code command based on a calculated heat time defining a time unit prior to when a non-active print head transitions to an active state.

4. The system as recited in claim 1, wherein the G-node data comprises at least one of a time to produce a line, a quantity of head movements, a head direction, a time to print a line, or maximum velocities at corners.

5. The system as recited in claim 1, wherein the processor is further programmed to generate the plurality of G-node segments.

6. The system as recited in claim 5, wherein the plurality of G-node segments include G-node data corresponding to at least one print head.

7. The system as recited in claim 6, wherein the G-node segments include at least one segment separator that separates G-node data corresponding to a first print head from G-node data corresponding to a second print head.

8. The system as recited in claim 7, wherein each window of the plurality of windows comprise a set of G-node data.

9. The system as recited in claim 8, wherein the processor is further programmed to assign the set of G-node data based on a time parameter.

10. The system as recited in claim 9, wherein the processor is further programmed to assign the set of G-node data such that a sum of total time parameters of the set of G-node data does not exceed a predetermined time threshold.

11. The system as recited in claim 10, wherein the processor is further programmed to generate a new window when the sum exceeds the predetermined time threshold.

12. The system as recited in claim 11, wherein the processor is further programmed to assign another set of G-node data to the new window.

13. The system as recited in claim 1, wherein the processor is further programmed to access a lookup table to determine the G-code heat command to insert into the G-code command file.

14. The system as recited in claim 13, wherein the lookup table includes a linear model that relates overall average velocity to a temperature for a heated nozzle.

15. The system as recited in claim 14, wherein the overall average velocity corresponds to a sum of x-y velocities of individual G-code commands within at least one window of the plurality of windows.

16. The system as recited in claim 13, wherein the lookup table includes a polynomial model that relates overall average velocity to a temperature for a heated nozzle.

17. The system as recited in claim 16, wherein the overall average velocity corresponds to a sum of x-y velocities of individual G-code commands within at least one window of the plurality of windows.

18. A system comprising a computer including a processor and a memory, the memory including instructions such that the processor is programmed to:
retrieve 3D printer identification data;
access and retrieve 3D print job data from at least one repository based on an input and the 3D printer identification data; and
generate a command file based on the 3D print job data.

19. The system as recited in claim 18, wherein the at least one repository comprises at least one of a vendor domain repository, an application programming interface (API) wrapper repository, or a G-node repository.

20. The system as recited in claim 18, wherein the command file is transmitted to a 3D printer to perform a print job according to the command file.
